(19) United States
(12) Patent Application Publication
(10) Pub. No.: US 2019/0149298 A1
(43) Pub. Date: May 16, 2019

(54) Reference Signals With Improved Cross-Correlation Properties In Wireless Communications

(71) Applicant: MediaTek Inc., Hsinchu City (TW)

(72) Inventor: Weidong Yang, San Diego, CA (US)

(21) Appl. No.: 16/190,146

(22) Filed: Nov. 14, 2018

Related U.S. Application Data
(60) Provisional application No. 62/586,262, filed on Nov. 15, 2017.
(60) Provisional application No. 62/588,195, filed on Nov. 17, 2017.

(51) Int. Cl. H04L 5/00; H04W 72/02; H04L 27/20; H04B 7/0452; H04B 7/0456; H04W 72/04

(52) U.S. Cl. CPC H04L 5/0051; H04W 72/02; H04L 27/2032; H04W 72/042; H04B 7/0456; H04W 72/0446; H04B 7/0452

(57) ABSTRACT

Various examples with respect to generation of reference signals with improved cross-correlation properties in wireless communications are described. A processor of a user equipment (UE) selects a column of a Hadamard matrix to provide a vector and also generates a pseudo-random sequence. The processor scrambles the vector with the pseudo-random sequence to provide a scrambling sequence and performs a cyclic shift on the scrambling sequence to provide a cyclic-shifted scrambling sequence. The processor then generates a reference signal by performing a pi/2-binary phase shift keying (BPSK) modulation on the cyclic-shifted scrambling sequence.

### CROSS REFERENCE TO RELATED PATENT APPLICATION(S)

The present disclosure is part of a non-provisional application claiming the priority benefit of U.S. Patent Application Nos. 62/586,262 and 62/588,195, filed on 15 Nov. 2017 and 17 Nov. 2017, respectively, the contents of which are incorporated by reference in their entirety.

### TECHNICAL FIELD

The present disclosure is generally related to wireless communications and, more particularly, to generation of reference signals with improved cross-correlation properties in wireless communications.

### BACKGROUND

Unless otherwise indicated herein, approaches described in this section are not prior art to the claims listed below and are not admitted as prior art by inclusion in this section.

In the design of reference signals for wireless communications such as 5^{th}-Generation (5G)/New Radio (NR) mobile communications, it has been proposed that a Gold sequence be used to derive a reference signal such as a demodulation reference signal (DMRS) for pi/2-binary phase shift keying (BPSK). However, while the reference signal derived from the Gold sequence can lead to a low peak-to-average power ratio (PAPR), the cross-correlation properties of such reference signal may not be ideal. For instance, the PAPR of a DMRS for pi/2-BPSK can be higher than that of data. For two user equipment (UEs) using their respective radio network temporary identifiers (RNTIs) as scrambling seeds for physical uplink shared channel (PUSCH), there is no guarantee on the quality of the cross-correlation properties between the generated reference signals. Moreover, the correlation properties of truncated Gold sequences may not be ideal.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

In one aspect, a method may involve a processor of a user equipment (UE) selecting a column of a Hadamard matrix to provide a vector. The method may involve the processor generating a pseudo-random sequence. The method may also involve the processor scrambling the vector with the pseudo-random sequence to provide a scrambling sequence. The method may also involve the processor performing a cyclic shift on the scrambling sequence to provide a cyclic-shifted scrambling sequence. The method may also involve the processor generating a reference signal by performing a pi/2-BPSK modulation on the cyclic-shifted scrambling sequence.

In one aspect, an apparatus may include a processor. The processor may be capable of a number of operations, including: (1) selecting a column of a Hadamard matrix to provide a vector; (2) generating a pseudo-random sequence; (3) scrambling the vector with the pseudo-random sequence to provide a scrambling sequence; (4) performing a cyclic shift on the scrambling sequence to provide a cyclic-shifted scrambling sequence; and (5) generating a reference signal by performing a pi/2-BPSK modulation on the cyclic-shifted scrambling sequence.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies wherever applicable such as, for example and without limitation, Long-Term Evolution (LTE), LTE-Advanced, LTE-Advanced Pro, Internet-of-Things (IoT) and Narrow Band Internet of Things (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of example design for generation of reference signals with improved cross-correlation properties in accordance with an implementation of the present disclosure.

FIG. 2 is a diagram of an example wireless communication system in accordance with an implementation of the present disclosure.

FIG. 3 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to generation of reference signals with improved cross-correlation properties in wireless communications. According to the present disclosure, a number of possible schemes/solutions may be implemented separately or jointly. That is, although these possible solutions may be described below separately, two or more of these possible solutions may be implemented in one combination or another.

Under a proposed scheme in accordance with the present disclosure, the prime numbers 2, 3 and 5 may be factors of the number of physical resource blocks (PRBs) in NR uplink transmissions. Under the proposed scheme, it may be verified that the number of PRBs (herein denoted by L) may be less than 275 and meet the requirement of having the prime numbers 2, 3 and/or 5 (and no other prime numbers) as factors. For instance, L may be given by {1, 2, 3, 4, 5, 6, 8, 9, 10, 12, 15, 16, 18, 20, 24, 25, 27, 30, 32, 36, 40, 45, 48, 50, 54, 60, 64, 72, 75, 80, 81, 90, 96, 100, 108, 120, 125, 128, 135, 144, 150, 160, 162, 180, 192, 200, 216, 225, 240, 243, 250, 256, 270}. The number of resource elements (REs) for an allowable PUSCH may be a multiple of the number 12 and denoted as 12×L, as DMRS Under the proposed scheme, a Hadamard matrix of size N×N, with N=12×L, may be utilized in generating reference signals with improved cross-correlation properties. Here, L∈{1, 2, 3, 4, 5, 6, 8, 9, 10, 12, 15, 16, 18, 20, 24, 25, 27, 30, 32, 36, 40, 45, 48, 50, 54, 60, 64, 72, 75, 80, 81, 90, 96, 100, 108, 120, 125, 128, 135, 144, 150, 160, 162, 180, 192, 200, 216, 225, 240, 243, 250, 256, 270}.

With the given value of L, a Hadamard matrix of Lₕ columns by Lₕ rows (herein denoted by H, with Lₕ=12×L) may be generated as described below in accordance with the proposed scheme of the present disclosure. Firstly, and optionally, a row permutation may be applied to the obtained Hadamard matrix to obtain a matrix H1. A column of H1 may be chosen to obtain a vector v of length 12×L. The vector v may be scrambled by a pseudo-random sequence (e.g., a Gold sequence). Under the proposed scheme, the generation of H, the optional row permutation, the column selection and a scrambling seed used in the scrambling may be controlled by a UE identification (e.g., Cell Radio Network Temporary Identifier or C-RNTI), a cell identification (ID) of a cell with which the UE is associated, a slot index and/or a radio resource control (RRC) signaled scrambling ID. The Gold sequence, also known as a Gold code, is a type of binary sequence having bounded small cross-correlations within a set, which is useful when multiple devices (e.g., UEs) are broadcasting in the same frequency range. A set of Gold sequences typically includes 2ⁿ+1 sequences each having a period of 2ⁿ−1.

In a first approach under the proposed scheme, to facilitate Multi-User Multiple-Input Multiple-Output (MU-MIMO) in uplink transmissions, different columns may be chosen from the same matrix H1 for different UEs.

In a second approach under the proposed scheme, to facilitate MIMO in uplink transmissions, for the same matrix H a first UE (UE1) may use a row permutation of [1 2 . . . Lₕ] and a cyclic shift of [1 2 . . . Lₕ] (e.g., [3 4 . . . Lₕ 1 2]). Moreover, the vector v may be chosen at the same column from each respective H1 for each UE. Additionally, the scrambling sequence may be adjusted according to the amount of cyclic shift, so that resultant sequences may be cyclic-shifted versions of each other. Moreover, cyclic prefixes may be added to the resultant sequences. Accordingly, a single Toeplitz formulation may be used to estimate the channel response for the UEs.

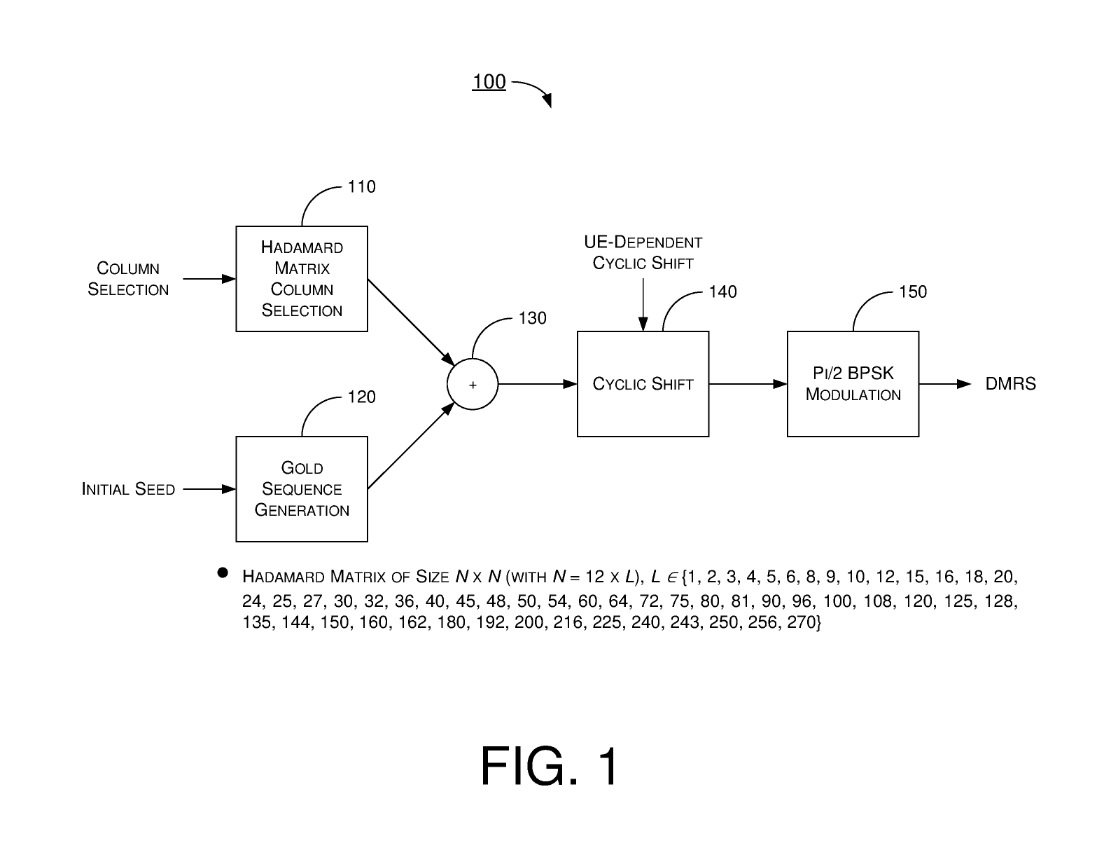

FIG. 1 illustrates an example design 100 for generation of reference signals with improved cross-correlation properties in accordance with an example implementation of the present disclosure. Design 100 may involve a number of functional blocks such as functional blocks 110, 120, 130, 140 and 150. Each of functional blocks 110, 120, 130, 140 and 150 may be implemented in hardware or a combination of hardware and software. Although illustrated as discrete blocks, two or more of the functional blocks of design 100 may be divided into additional blocks, combined into fewer blocks, or eliminated, depending on the desired implementation. Design 100 may be implemented in a processor of a UE to generate reference signals (e.g., DMRS) with improved cross-correlation properties in accordance with the present disclosure.

Functional block 110 may involve an optional row permutation and a selection of a column from a Hadamard matrix. The size of the Hadamard matrix may be N×N, with N=12×L. Here, L may be a multiple of one or more of prime numbers 2, 3 and 5 and less than 275. The selected column may be a vector v of length 12×L. For instance, functional block 110 may first perform a row permutation on the Hadamard matrix to provide a matrix and then select one of the columns of the matrix as the vector v. Alternatively, functional block 110 may select one of the columns of the Hadamard matrix to provide the vector v.

In some implementations, the optional row permutation and/or which column of the Hadamard matrix to be selected may be configured by a network to which the UE is wirelessly connected. For instance, the optional row permutation and/or the column selection may be indicated, controlled or otherwise configured by the network via control signaling such as, for example and without limitation, RRC signaling. In some implementations, the optional row permutation and/or which column of the Hadamard matrix to be selected may be UE-dependent and thus determined by the UE itself. For instance, the UE may determine the optional row permutation and/or column selection based on its UE identification (e.g., C-RNTI), a cell ID of a cell with which the UE is associated or a slot index.

Functional block 120 may involve generation of a pseudo-random sequence (e.g., a Gold sequence) based on an initial seed. In some implementations, a network may indicate, assign or otherwise configure the same initial seed or scrambling ID to each UE connected to the network. Accordingly, each UE connected to the network may generate the same pseudo-random sequence. In some implementations, the network may indicate, assign or otherwise configure cell-specific initial seeds to multiple cells associated with the network. That is, UEs in the same cell may share the same cell-specific initial seed, and UEs in different cells may have different initial seeds. Accordingly, UEs of the same cell may generate the same pseudo-random sequence which is different from that generated by UEs of a different cell. The initial seed may be indicated, assigned or otherwise configured by the network via control signaling such as, for example and without limitation, RRC control signaling. Alternatively, the initial seed may be UE-dependent and thus determined by the UE itself. For instance, the UE may determine the initial seed based on its UE identification (e.g., C-RNTI), a cell ID of a cell with which the UE is associated or a slot index.

Functional block 130 may involve scrambling of vector v (which is the selected column of the Hadamard matrix) with the generated pseudo-random sequence using a mathematical or logical operation. For example, in the complex number domain, a multiplication operation may be performed by functional block 130 to multiply vector v with the generated pseudo-random sequence to generate a scrambling sequence. As another example, in the binary domain, a bitwise exclusive OR (XOR) operation may be performed between bits of the vector and bits of the generated pseudo-random sequence to generate the scrambling sequence.

Functional block 140 may involve performing a cyclic shift on the scrambling sequence generated by functional block 130. The amount of cyclic shift to be performed may be UE-dependent. That is, a number of bits of cyclic shift to be performed on the scrambling sequence may be determined by the UE independently.

Functional block 150 may involve performing a pi/2-BPSK modulation on the cyclic-shifted scrambling sequence to generate a reference signal (e.g., DMRS) for transmission (e.g., uplink transmission to the network).

In view of the above, it can be seen that design 100 differs from conventional approaches of generation of a reference signal in a number of ways. For instance, in conventional approaches, there is no column selection (and optional row permutation) from a Hadamard matrix to select a vector that is scrambled with a pseudo-random sequence (e.g., Gold sequence). Moreover, in conventional approaches, there is no UE-dependent cyclic shifting of the scrambling sequence before the pi/2-BPSK modulation to generate the reference signal. Accordingly, it is believed that design 100 can provide reference signals (e.g., DMRS) such that cross-correlation properties between the reference signals generated by different UEs may be improved.

### Illustrative Implementations

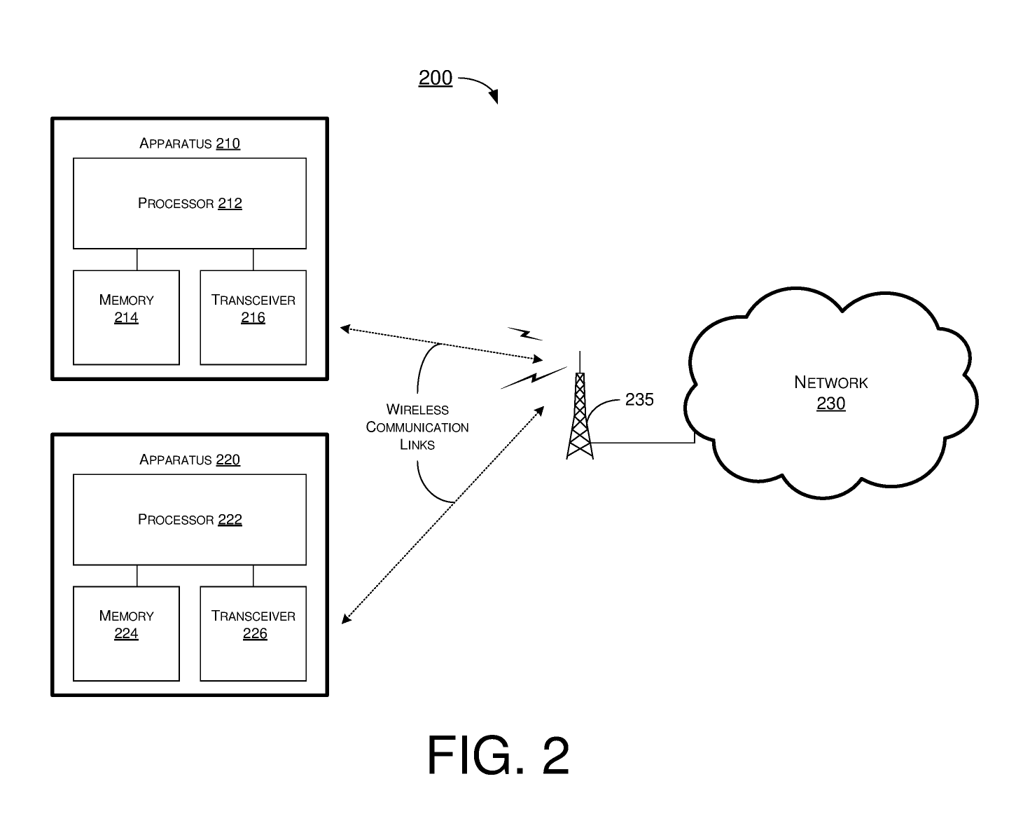

FIG. 2 illustrates an example wireless communication system 200 in accordance with an implementation of the present disclosure. Wireless communication system 200 may involve an apparatus 210 and an apparatus 220 wirelessly communicating with a wireless network 230 via a network node or base station 235 (e.g., gNB). Each of apparatus 210 and apparatus 220 may perform various functions to implement procedures, schemes, techniques, processes and methods described herein pertaining to generation of reference signals with improved cross-correlation properties in wireless communications, including the various procedures, scenarios, schemes, solutions, concepts and techniques described above as well as process 300 described below.

Each of apparatus 210 and apparatus 220 may be a part of an electronic apparatus, which may be a UE such as a portable or mobile apparatus, a wearable apparatus, a wireless communication apparatus or a computing apparatus. For instance, each of apparatus 210 and apparatus 220 may be implemented in a smartphone, a smartwatch, a personal digital assistant, a digital camera, or a computing equipment such as a tablet computer, a laptop computer or a notebook computer. Moreover, each of apparatus 210 and apparatus 220 may also be a part of a machine type apparatus, which may be an IoT or NB-IoT apparatus such as an immobile or a stationary apparatus, a home apparatus, a wire communication apparatus or a computing apparatus. For instance, each of apparatus 210 and apparatus 220 may be implemented in a smart thermostat, a smart fridge, a smart door lock, a wireless speaker or a home control center. Alternatively, each of apparatus 210 and apparatus 220 may be implemented in the form of one or more integrated-circuit (IC) chips such as, for example and without limitation, one or more single-core processors, one or more multi-core processors, one or more reduced-instruction-set-computing (RISC) processors or one or more complex-instruction-set-computing (CISC) processors.

Each of apparatus 210 and apparatus 220 may include at least some of those components shown in FIG. 2 such as a processor 212 and a processor 222, respectively. Each of apparatus 210 and apparatus 220 may further include one or more other components not pertinent to the proposed scheme of the present disclosure (e.g., internal power supply, display device and/or user interface device), and, thus, such component(s) of each of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, one or more RISC processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks pertaining to generation of reference signals with improved cross-correlation properties in wireless communications in accordance with various implementations of the present disclosure. In some implementations, each of processor 212 and processor 222 may include an electronic circuit with hardware components implementing design 100 to generate reference signals with improved cross-correlation properties in wireless communications in accordance with various implementations of the present disclosure. Alternatively, other than hardware components, each of processor 212 and processor 222 may also utilize software codes and/or instructions in addition to hardware components to implement design 100 to generate reference signals with improved cross-correlation properties in wireless communications in accordance with various implementations of the present disclosure.

In some implementations, apparatus 210 may also include a transceiver 216 coupled to processor 212 and capable of wirelessly transmitting and receiving data, signals and information. In some implementations, transceiver 216 may be equipped with a plurality of antenna ports (not shown) such as, for example, four antenna ports. In some implementations, apparatus 210 may further include a memory 214 coupled to processor 212 and capable of being accessed by processor 212 and storing data therein. In some implementations, apparatus 220 may also include a transceiver 226 coupled to processor 222 and capable of wirelessly transmitting and receiving data, signals and information. In some implementations, apparatus 220 may further include a memory 224 coupled to processor 222 and capable of being accessed by processor 222 and storing data therein. Accordingly, apparatus 210 and apparatus 220 may wirelessly communicate with wireless network 230 via transceiver 216 and transceiver 226, respectively.

To aid better understanding, the following description of the operations, functionalities and capabilities of each of apparatus 210 and apparatus 220 is provided in the context of a mobile communication environment in which apparatus 210 is implemented in or as a first UE and apparatus 220 is implemented in or as a second UE, both wirelessly connected to wireless network 230 (e.g., 5G/NR mobile network).

Under various proposed schemes in accordance with the present disclosure, processor 212 of apparatus 210 may select a column of a Hadamard matrix to provide a vector. Additionally, processor 212 may generate a pseudo-random sequence. Moreover, processor 212 may scramble the vector with the pseudo-random sequence to provide a scrambling sequence. Furthermore, processor 212 may perform a cyclic shift on the scrambling sequence to provide a cyclic-shifted scrambling sequence. Also, processor 212 may generate a reference signal by performing a pi/2-BPSK modulation on the cyclic-shifted scrambling sequence. Processor 212 may also transmit, via transceiver 216, the reference signal to wireless network 230 to which apparatus 210 is wirelessly connected. In some implementations, the reference signal may include a DMRS.

Similarly, processor 222 of apparatus 220 may select a column of a Hadamard matrix to provide a vector. Additionally, processor 222 may generate a pseudo-random sequence. Moreover, processor 222 may scramble the vector with the pseudo-random sequence to provide a scrambling sequence. Furthermore, processor 222 may perform a cyclic shift on the scrambling sequence to provide a cyclic-shifted scrambling sequence. Also, processor 222 may generate a reference signal by performing a pi/2-BPSK modulation on the cyclic-shifted scrambling sequence. Processor 222 may also transmit, via transceiver 226, the reference signal to wireless network 230 to which apparatus 220 is wirelessly connected. In some implementations, the reference signal may include a DMRS.

In some implementations, a size of the Hadamard matrix may be N×N, with N=12×L. Moreover, L may be a multiple of one or more of prime numbers 2, 3 and 5 and less than 275. For instance, L∈{1, 2, 3, 4, 5, 6, 8, 9, 10, 12, 15, 16, 18, 20, 24, 25, 27, 30, 32, 36, 40, 45, 48, 50, 54, 60, 64, 72, 75, 80, 81, 90, 96, 100, 108, 120, 125, 128, 135, 144, 150, 160, 162, 180, 192, 200, 216, 225, 240, 243, 250, 256, 270}.

In some implementations, in selecting the column of the Hadamard matrix, processor 212 may first perform a row permutation on the Hadamard matrix to provide a matrix and then select a column of the matrix to provide the vector. For instance, processor 212 may decide to select a first column of the matrix to provide the vector. In some implementations, in selecting the column of the Hadamard matrix, processor 222 may first perform a row permutation on the Hadamard matrix to provide a matrix and then select a column of the matrix to provide the vector. For instance, processor 222 may decide to select a column (which may be the same as or different from the first column chosen by processor 212) to provide the vector.

In some implementations, in selecting the column of the Hadamard matrix, processor 212 may receive, via transceiver 216, a control signal from wireless network 230 to which apparatus 210 is wirelessly connected. Moreover, processor 212 may select the column of the matrix to provide the vector based on the control signal. In some implementations, in selecting the column of the Hadamard matrix, processor 222 may receive, via transceiver 226, a control signal from wireless network 230 to which apparatus 220 is wirelessly connected. Moreover, processor 222 may select the column of the matrix to provide the vector based on the control signal.

In some implementations, in selecting the column of the Hadamard matrix, processor 212 may select the column of the Hadamard matrix based on a UE ID of apparatus 210 (e.g., C-RNTI of apparatus 210), a cell ID of a cell with which apparatus 210 is associated, or a slot index. In some implementations, in selecting the column of the Hadamard matrix, processor 222 may select the column of the Hadamard matrix based on a UE ID of apparatus 220 (e.g., C-RNTI of apparatus 220), a cell ID of a cell with which apparatus 220 is associated, or a slot index.

In some implementations, in generating the pseudo-random sequence, processor 212 may generate a Gold sequence. In some implementations, in generating the pseudo-random sequence, processor 222 may generate a Gold sequence.

In some implementations, in generating the pseudo-random sequence, processor 212 may receive a control signal from wireless network 230 to which apparatus 210 is wirelessly connected. Additionally, processor 212 may generate the pseudo-random sequence using an initial seed indicated in the control signal. In some implementations, in generating the pseudo-random sequence, processor 222 may receive a control signal from wireless network 230 to which apparatus 220 is wirelessly connected. Moreover, processor 222 may generate the pseudo-random sequence using an initial seed indicated in the control signal. For instance, when apparatus 210 and apparatus 220 are associated with the same cell of wireless network 230, wireless network 230 may indicate, assign or otherwise configure processor 212 and processor 222 to use the same initial seed to generate the pseudo-random sequence. Moreover, when apparatus 210 and apparatus 220 are associated with different cells of wireless network 230, wireless network 230 may indicate, assign or otherwise configure processor 212 and processor 222 to use different initial seeds to generate the pseudo-random sequence.

In some implementations, in generating the pseudo-random sequence, processor 212 may generate the pseudo-random sequence based on a UE ID of apparatus 210 (e.g., C-RNTI of apparatus 210), a cell ID of a cell with which apparatus 210 is associated, or a slot index. In some implementations, in generating the pseudo-random sequence, processor 222 may generate the pseudo-random sequence based on a UE ID of apparatus 220 (e.g., C-RNTI of apparatus 220), a cell ID of a cell with which apparatus 220 is associated, or a slot index.

In some implementations, in scrambling the vector with the pseudo-random sequence, processor 212 may perform a bitwise exclusive OR (XOR) operation between bits of the vector and bits of the pseudo-random sequence to generate the scrambling sequence. In some implementations, in scrambling the vector with the pseudo-random sequence, processor 222 may perform a bitwise exclusive OR (XOR) operation between bits of the vector and bits of the pseudo-random sequence to generate the scrambling sequence.

In some implementations, in performing the cyclic shift on the scrambling sequence, processor 212 may determine a number of bits of cyclic shift to be performed. Additionally, processor 212 may cyclically shift the scrambling sequence by the number of bits to generate the cyclic-shifted scrambling sequence. In some implementations, in performing the cyclic shift on the scrambling sequence, processor 222 may determine a number of bits of cyclic shift to be performed. Additionally, processor 222 may cyclically shift the scrambling sequence by the number of bits to generate the cyclic-shifted scrambling sequence.

### Illustrative Processes

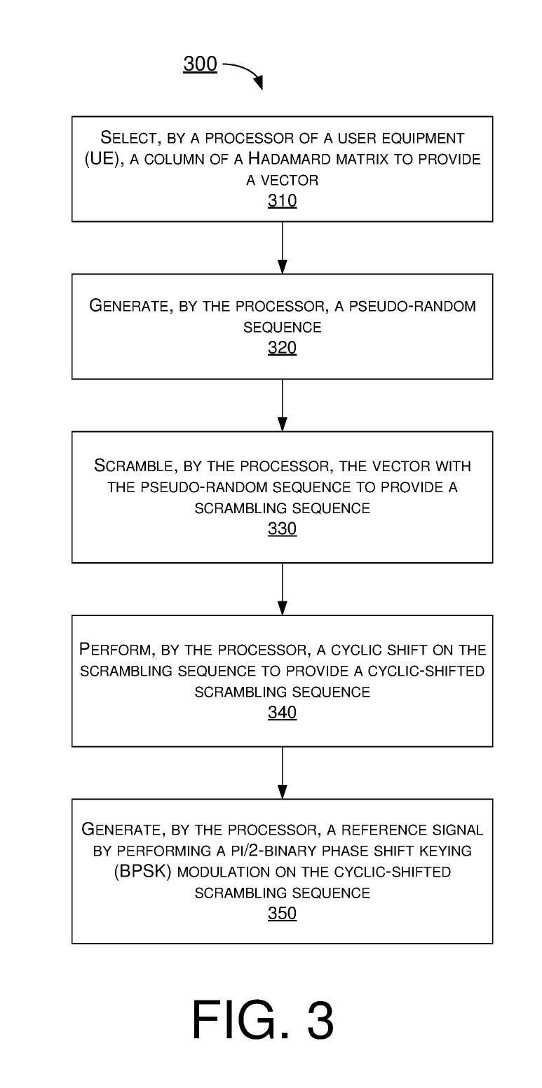

FIG. 3 illustrates an example process 300 in accordance with an implementation of the present disclosure. Process 300 may be an example implementation of the various procedures, scenarios, schemes, solutions, concepts and techniques, or a combination thereof, whether partially or completely, with respect to generation of reference signals with improved cross-correlation properties in wireless communications in accordance with the present disclosure. Process 300 may represent an aspect of implementation of features of apparatus 210 and/or apparatus 220. Process 300 may include one or more operations, actions, or functions as illustrated by one or more of blocks 310, 320, 330, 340 and 350. Although illustrated as discrete blocks, various blocks of process 300 may be divided into additional blocks, combined into fewer blocks, or eliminated, depending on the desired implementation. Moreover, the blocks of process 300 may executed in the order shown in FIG. 3 or, alternatively, in a different order. Furthermore, one or more of the blocks of process 300 may be repeated one or more times. Process 300 may be implemented by apparatus 210 or any suitable UE or machine type devices. Solely for illustrative purposes and without limitation, process 300 is described below in the context of apparatus 210 as a UE of a wireless network. Process 300 may begin at block 310.

At 310, process 300 may involve processor 212 of apparatus 210 selecting a column of a Hadamard matrix to provide a vector. Process 300 may proceed from 310 to 320.

At 320, process 300 may involve processor 212 generating a pseudo-random sequence. Process 300 may proceed from 320 to 330.

At 330, process 300 may involve processor 212 scrambling the vector with the pseudo-random sequence to provide a scrambling sequence. Process 300 may proceed from 330 to 340.

At 340, process 300 may involve processor 212 performing a cyclic shift on the scrambling sequence to provide a cyclic-shifted scrambling sequence. Process 300 may proceed from 340 to 350.

At 350, process 300 may involve processor 212 generating a reference signal by performing a pi/2-BPSK modulation on the cyclic-shifted scrambling sequence.

In some implementations, a size of the Hadamard matrix may be N×N, with N=12×L. Moreover, L may be a multiple of one or more of prime numbers 2, 3 and 5 and less than 275. For instance, L∈{1, 2, 3, 4, 5, 6, 8, 9, 10, 12, 15, 16, 18, 20, 24, 25, 27, 30, 32, 36, 40, 45, 48, 50, 54, 60, 64, 72, 75, 80, 81, 90, 96, 100, 108, 120, 125, 128, 135, 144, 150, 160, 162, 180, 192, 200, 216, 225, 240, 243, 250, 256, 270}.

In some implementations, in selecting the column of the Hadamard matrix, process 300 may involve processor 212 first performing a row permutation on the Hadamard matrix to provide a matrix and then selecting a column of the matrix to provide the vector.

In some implementations, in selecting the column of the Hadamard matrix, process 300 may involve processor 212 receiving, via transceiver 216, a control signal from wireless network 230 to which apparatus 210 is wirelessly connected. Moreover, process 300 may involve processor 212 selecting the column of the matrix to provide the vector based on the control signal.

In some implementations, in selecting the column of the Hadamard matrix, process 300 may involve processor 212 selecting the column of the Hadamard matrix based on a UE ID of apparatus 210 (e.g., C-RNTI of apparatus 210), a cell ID of a cell with which apparatus 210 is associated, or a slot index.

In some implementations, in generating the pseudo-random sequence, process 300 may involve processor 212 generating a Gold sequence.

In some implementations, in generating the pseudo-random sequence, process 300 may involve processor 212 receiving a control signal from wireless network 230 to which apparatus 210 is wirelessly connected. Additionally, process 300 may involve processor 212 generating the pseudo-random sequence using an initial seed indicated in the control signal.

In some implementations, in generating the pseudo-random sequence, process 300 may involve processor 212 generating the pseudo-random sequence based on a UE ID of apparatus 210 (e.g., C-RNTI of apparatus 210), a cell ID of a cell with which apparatus 210 is associated, or a slot index.

In some implementations, in scrambling the vector with the pseudo-random sequence, process 300 may involve processor 212 performing a bitwise exclusive OR (XOR) operation between bits of the vector and bits of the pseudo-random sequence to generate the scrambling sequence.

In some implementations, in performing the cyclic shift on the scrambling sequence, process 300 may involve processor 212 determining a number of bits of cyclic shift to be performed. Additionally, process 300 may involve processor 212 cyclically shifting the scrambling sequence by the number of bits to generate the cyclic-shifted scrambling sequence.

In some implementations, process 300 may further involve processor 212 transmitting, via transceiver 216, the reference signal to wireless network 230 to which the UE is wirelessly connected. In some implementations, the reference signal may include a DMRS.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
selecting, by a processor of a user equipment (UE), a column of a Hadamard matrix to provide a vector;
generating, by the processor, a pseudo-random sequence;
scrambling, by the processor, the vector with the pseudo-random sequence to provide a scrambling sequence;
performing, by the processor, a cyclic shift on the scrambling sequence to provide a cyclic-shifted scrambling sequence; and
generating, by the processor, a reference signal by performing a pi/2-binary phase shift keying (BPSK) modulation on the cyclic-shifted scrambling sequence.

2. The method of claim 1, wherein the selecting of the column of the Hadamard matrix comprises:
performing a row permutation on the Hadamard matrix to provide a matrix; and
selecting a column of the matrix to provide the vector.

3. The method of claim 1, wherein the selecting of the column of the Hadamard matrix comprises:
receiving a control signal from a network to which the UE is wirelessly connected; and
selecting the column of the matrix to provide the vector based on the control signal.

4. The method of claim 1, wherein the selecting of the column of the Hadamard matrix comprises selecting the column of the Hadamard matrix based on a UE identification (ID), a cell ID of a cell with which the UE is associated, or a slot index.

5. The method of claim 1, wherein the generating of the pseudo-random sequence comprises generating a Gold sequence.

6. The method of claim 1, wherein the generating of the pseudo-random sequence comprises:
receiving a control signal from a network to which the UE is wirelessly connected; and
generating the pseudo-random sequence using an initial seed indicated in the control signal.

7. The method of claim 1, wherein the generating of the pseudo-random sequence comprises generating the pseudo-random sequence based on a UE identification (ID), a cell ID of a cell with which the UE is associated, or a slot index.

8. The method of claim 1, wherein the scrambling of the vector with the pseudo-random sequence comprises performing a bitwise exclusive OR (XOR) operation between bits of the vector and bits of the pseudo-random sequence to generate the scrambling sequence.

9. The method of claim 1, wherein the performing of the cyclic shift on the scrambling sequence comprises:
determining a number of bits of cyclic shift to be performed; and
cyclically shifting the scrambling sequence by the number of bits to generate the cyclic-shifted scrambling sequence.

10. The method of claim 1, further comprising:
transmitting, by the processor, the reference signal to a network to which the UE is wirelessly connected,
wherein the reference signal comprises a demodulation reference signal (DMRS).

11. An apparatus, comprising:
a processor capable of:
selecting a column of a Hadamard matrix to provide a vector;
generating a pseudo-random sequence;
scrambling the vector with the pseudo-random sequence to provide a scrambling sequence;
performing a cyclic shift on the scrambling sequence to provide a cyclic-shifted scrambling sequence; and
generating a reference signal by performing a pi/2-binary phase shift keying (BPSK) modulation on the cyclic-shifted scrambling sequence.

12. The apparatus of claim 11, wherein, in selecting the column of the Hadamard matrix, the processor is capable of:
performing a row permutation on the Hadamard matrix to provide a matrix; and
selecting a column of the matrix to provide the vector.

13. The apparatus of claim 11, wherein, in selecting the column of the Hadamard matrix, the processor is capable of:
receiving a control signal from a network to which the apparatus is wirelessly connected; and
selecting the column of the matrix to provide the vector based on the control signal.

14. The apparatus of claim 11, wherein, in selecting the column of the Hadamard matrix, the processor is capable of selecting the column of the Hadamard matrix based on a UE identification (ID), a cell ID of a cell with which the apparatus is associated, or a slot index.

15. The apparatus of claim 11, wherein, in generating the pseudo-random sequence, the processor is capable of generating a Gold sequence.

16. The apparatus of claim 11, wherein, in generating the pseudo-random sequence, the processor is capable of:
receiving a control signal from a network to which the apparatus is wirelessly connected; and
generating the pseudo-random sequence using an initial seed indicated in the control signal.

17. The apparatus of claim 11, wherein, in generating the pseudo-random sequence, the processor is capable of generating the pseudo-random sequence based on a UE identification (ID), a cell ID of a cell with which the apparatus is associated, or a slot index.

18. The apparatus of claim 11, wherein, in scrambling the vector with the pseudo-random sequence, the processor is capable of performing a bitwise exclusive OR (XOR) operation between bits of the vector and bits of the pseudo-random sequence to generate the scrambling sequence.

19. The apparatus of claim 11, wherein, in performing the cyclic shift on the scrambling sequence, the processor is capable of:
determining a number of bits of cyclic shift to be performed; and
cyclically shifting the scrambling sequence by the number of bits to generate the cyclic-shifted scrambling sequence.

20. The apparatus of claim 11, further comprising:
a transceiver capable of wirelessly communicating with a network,
wherein the processor is further capable of transmitting, via the transceiver, the reference signal to the network, and
wherein the reference signal comprises a demodulation reference signal (DMRS).
